(19) United States
(12) Patent Application Publication
(10) Pub. No.: US 2011/0291521 A1
(43) Pub. Date: Dec. 1, 2011

(54) STATOR FOR AN INDUCTION MOTOR

(75) Inventors: Richard M. Kleber, Clarkston, MI (US); Michael J. Walker, Windsor (CA); Thomas A. Perry, Bruce Township, MI (US)

(73) Assignee: GM GLOBAL TECHNOLOGY OPERATIONS, INC., DETROIT, MI (US)

(21) Appl. No.: 12/791,184

(22) Filed: Jun. 1, 2010

(51) Int. Cl. H02K 1/16

(52) U.S. Cl. 310/216.069

(57) ABSTRACT

A substantially hollow cylindrical stator core having a longitudinal axis includes a plurality of winding slots longitudinally parallel with the longitudinal axis each having first and second ends wherein the slots taper progressively larger closer to the ends of the slots.

### TECHNICAL FIELD

This disclosure is related to stators for induction motors.

### BACKGROUND

The statements in this section merely provide background information related to the present disclosure and may not constitute prior art.

An electric-powered induction motor transforms electric power to mechanical power by inducing rotating magnetic fields between a static element, i.e., a stator, and a rotatable element, i.e., a rotor. The rotating magnetic fields induce torque on a shaft of the rotor. Known stators can induce current flows through conductor bars on the rotor that are parallel to an axis of the motor.

A known rotor for an induction motor includes a stack of steel sheets assembled onto a rotatable shaft and a plurality of conducting bars fabricated from conductive material, e.g., copper or aluminum. The conducting bars are preferably connected at both axial ends of the rotors using shorting rings. The rotatable shaft of the rotor is mounted on bearing surfaces on end caps of a case containing the induction motor. Known rotor fabrication methods include assembling the stack of steel laminated sections, and then inserting the shorting bars and the conducting bars. Known methods for inserting the shorting bars and the conducting bars on the rotor include placing the rotor in a die cast mold and injecting molten material into open spaces formed in the rotor and open spaces between the die cast mold and the rotor.

Known stators for induction motors include a stator core and electrical wire windings. Known stator cores are cylindrically shaped devices constructed from laminated steel sheets. An inner circumference of a known stator core includes a plurality of radially-oriented slots into which electrical wire windings are installed. Known electrical wiring windings include strands of insulated wire that are woven or otherwise arranged into a plurality of coil groups, with each coil group providing a single pole of a single phase of motor operation. The insulated wire that is fabricated from suitable conductive material, e.g., copper or aluminum. The quantity of radially-oriented slots in the stator core is determined based upon the quantity of phases and poles of the electrical wiring windings for the induction motor. Thus, a three phase, two-pole induction motor will have electrical wiring windings that are configured as six coil groups, with the coil groups configured in six slots or a quantity of slots that is a multiple of six. Current flow through the electrical wire windings is used to generate the rotating magnetic fields that act on a rotor to induce torque on a shaft of the rotor.

Known parameters associated with induction motors include packaging size, mass, amount of materials used, e.g., the insulated wire, including amount of excess material that is used, and power density. The amount of excess material that is used in a stator includes that amount of material in the electrical wiring windings that is necessary for wrapping around, folding back or otherwise connecting individual strands of the insulated wire at one or both ends of the stator core and does not directly contribute to generating rotating magnetic fields in the stator.

### SUMMARY

A substantially hollow cylindrical stator core having a longitudinal axis includes a plurality of winding slots longitudinally parallel with the longitudinal axis each having first and second ends wherein the slots taper progressively larger closer to the ends of the slots.

### BRIEF DESCRIPTION OF THE DRAWINGS

One or more embodiments will now be described, by way of example, with reference to the accompanying drawings, in which:

FIG. 1 schematically illustrates a fragmentary perspective view of a portion of a stator for an induction motor in accordance with the present disclosure;

FIG. 2 schematically illustrates a side view of a stator core in accordance with the present disclosure;

FIG. 3 schematically illustrates a front view of a stator core in accordance with the present disclosure;

FIG. 4 schematically illustrates a fragmentary cutaway front view of the stator in accordance with the present disclosure; and

FIG. 5 schematically illustrates a fragmentary cutaway top view of the stator including adjacent radially-oriented inwardly projecting teeth forming a tapered aperture in accordance with the present disclosure.

### DETAILED DESCRIPTION

Referring now to the drawings, wherein the showings are for the purpose of illustrating certain exemplary embodiments only and not for the purpose of limiting the same, FIG. 1 schematically illustrates a fragmentary perspective view of a portion of a stator 10 for an induction motor. The induction motor can be any induction motor, with one application including an induction motor for use on a powertrain system for a motor vehicle. The stator 10 includes a hollow cylindrical stator core 11 and electrical wire windings 50 that are assembled into the stator core 11. As shown, the electrical wire windings 50 are fabricated using a plurality of insulated electric cables 52 that are arranged into a plurality of coil groups, with each coil group providing a single pole of a single phase of motor operation. The electrical wire windings 50 are arranged in any suitable winding pattern, including, e.g., a lap winding pattern and a concentric winding pattern, and installed into winding slots 18 formed in the stator core 11. The slots 18 are rectangularly-shaped conduits for the insulated electric cables 52. Electric power leads from each coil group are electrically connected to any suitable electric power source, including, e.g., a high-voltage battery and an inverter device. In one embodiment each of the insulated electric cables 52 is a single-strand copper wire that is fabricated from copper or aluminum and preformed into a shape that facilitates insertion into one of the slots 18 of the stator core 11. In one embodiment, the insulated electric cables 52 are solid copper bars having a cross-section that is approximately square, having dimensions of about 3 mm (⅛ in), and referred to as bar pin wires. The insulated electric cables 52 preferably have an electrical insulative coating that is a glossy translucent elastomeric coating preferably applied in a dip process. Each of the insulated electric cables 52 emerges from a radially-oriented tapered aperture 28 formed at an end of one of the slots 18. Each insulated electric cable 52 is bent to fold back and connect to another of the insulated electric cables 52, preferably by an electric welding process as part of forming one of the coil groups. As is appreciated, the magnitude of allowable or achievable bending of each of the insulated electric cables 52 is determined by magnitude of tapering of the apertures 28 of the slots 18. The stator 10 is inserted into any housing suitable for mounting and fixturing the stator 10. The stator 10 is configured to accommodate an inserted rotor assembly having a shaft portion, which rotates within the housing in response to electric power signals originating from the electric power source.

FIG. 2 schematically illustrates a side view of the stator core 11. The stator core 11 includes an assembled laminate stack 13 that has been fabricated using a plurality of flat steel plies 12 oriented on a longitudinal axis 15. The flat steel plies 12 are preferably stamped using a fine blanking process and are electrically insulated. Each of the flat steel plies 12 is a flat annular-shaped element. The assembled laminate stack 13 forms a plurality of radially-oriented, inwardly opening slots 18 each having a longitudinal axis that is parallel to the longitudinal axis 15. The assembled laminate stack 13 includes first and second ends 14 and 16, respectively that are perpendicular to the longitudinal axis 15. An end element 20 is assembled onto one end 14 of the assembled laminate stack 13. It is appreciated that the end element 20 may be assembled onto one end 14, or alternatively, there may be first and second end elements assembled onto the first and second ends 14, 16 respectively of the assembled laminate stack 13.

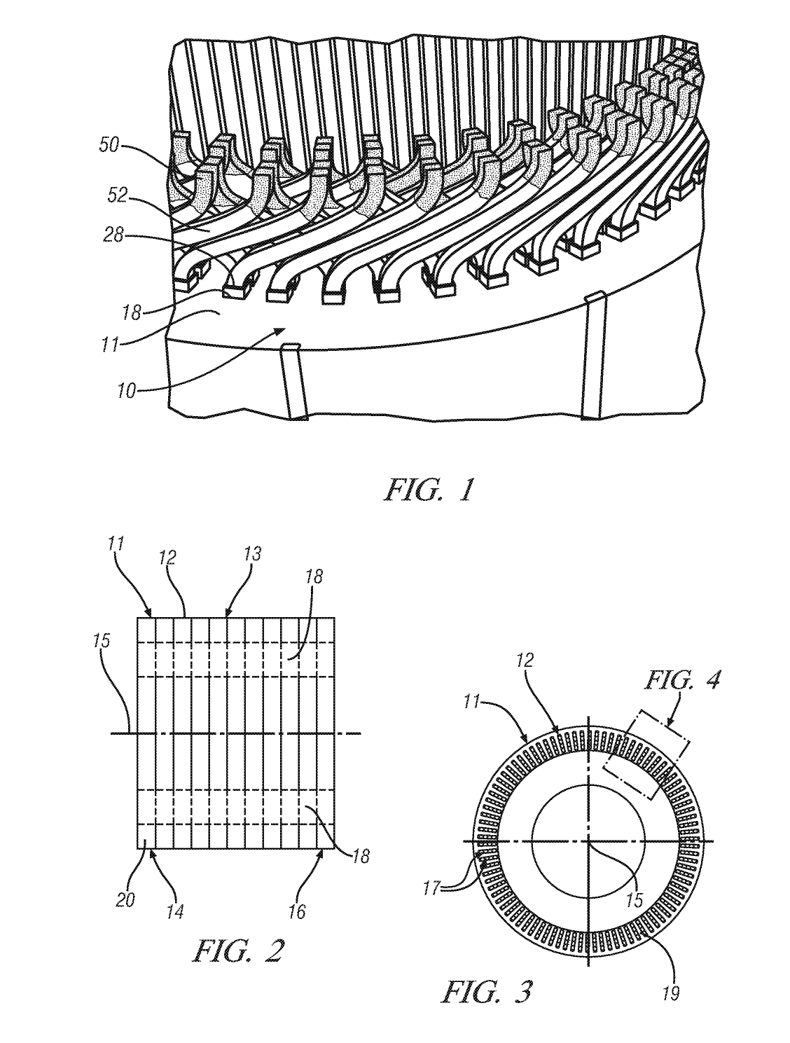

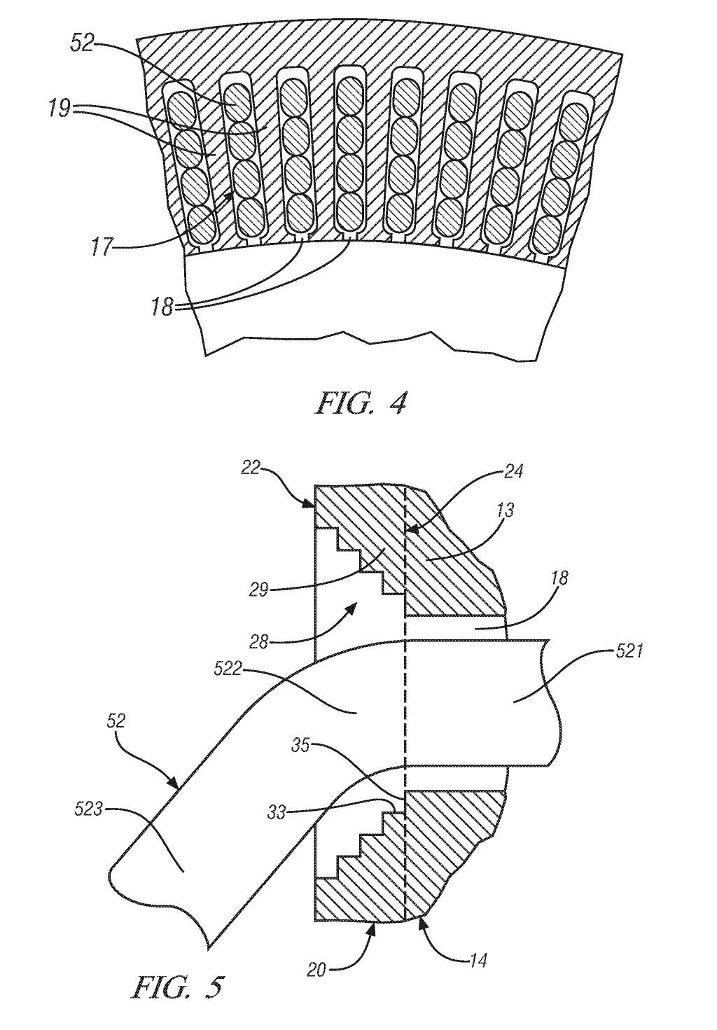

FIG. 3 schematically illustrates a front view of the stator core 11 and FIG. 4 schematically illustrates a fragmentary cutaway front view of the stator core 11. FIG. 3 schematically illustrates a front view of the stator core 11 including details of one of the flat steel plies 12. Each of the flat steel plies 12 includes a plurality of radially-oriented inwardly projecting teeth 19, with contiguous pairs of the teeth 19 forming an inwardly opening aperture 17 oriented radial to the longitudinal axis 15. The inwardly opening apertures 17 are depicted as having rectangular cross-sections, and may be any suitable shape for accommodating the electrical wire windings 50. As is appreciated, the flat steel plies 12 are assembled in a laminated fashion to form the assembled laminate stack 13 using any suitable fabricating method. The radially-oriented inwardly opening apertures 17 are aligned to form the corresponding inwardly opening slots 18 and preferably extend parallel to the longitudinal axis 15. The insulated electric cables 52 are inserted into the inwardly opening slots 18.

FIG. 5 schematically illustrates a fragmentary cutaway top view of the stator 10 including the assembled laminate stack 13 and the end element 20, which is coaxial with the assembled laminate stack 13 and includes an outer surface 22 and an inner surface 24. The inner surface 24 of the end element 20 is mounted contiguous to one of the ends 14, 16 of the assembled laminate stack 13. The end element 20 has a plurality of radially-oriented inwardly projecting teeth 29. The radially-oriented inwardly projecting teeth 29 correspond to the radially-oriented inwardly projecting teeth 19 of the assembled laminate stack 13. Contiguous pairs of the radially-oriented inwardly projecting teeth 29 form radially-oriented inwardly opening tapered apertures 28 that conform to the inwardly opening apertures 17 and the associated inwardly opening slots 18 of the assembled laminate stack 13. Each of the radially-oriented inwardly projecting teeth 29 includes a cross-sectional area that expands from the outer surface 22 to the inner surface 24 of the end element 20 relative to the longitudinal axis 15. As such, the radially-oriented inwardly opening tapered apertures 28 each taper, or diminish in cross-sectional area from the outer surface 22 to the inner surface 24 of the end element 20. In one embodiment, the reduction in cross-sectional area in each tapered aperture 28 from the outer surface 22 to the inner surface 24 is formed using a plurality of discrete steps 33 and corresponding plateaus 35 in each of the inwardly projecting teeth 29. The discrete steps 33 and corresponding plateaus 35 are formed using a plurality of plies having apertures that decrease in their respective open areas. Alternatively, the reduction in open area of the tapered apertures 28 from the outer surface 22 to the inner surface 24 is formed by machining a continuous chamfer or radius into the end element 20 when the end element is formed as a unitary piece. A single one of the insulated electric cables 52 is shown passing through one of the inwardly opening slots 18 and the tapered aperture 28.

The single insulated electric cable 52 includes a first portion 521 contained in the inwardly opening slot 18 of the stator core 11, a bend portion 522 contained within the tapered aperture 28, and an exterior portion 523 that is exterior to the stator core 11. In one embodiment the insulated electric cables 52 are preformed into a shape that facilitates insertion into the slots 18 in the assembled laminate stack 13 with the exterior portion 523 that is exterior to the stator core 11 welded to another of the insulated electric cables 52 at its exterior portion 523 that is exterior to the stator core 11. The exterior portion 523 of each of the insulated cables 52 includes material that is necessary for wrapping around or folding back to electrically and mechanically connect with other insulated electric cables 52. It is appreciated that the radially-oriented inwardly opening tapered apertures 28 facilitate use of a greater angle for the bend portions 522 of the insulated electric cables 52 than achievable with a no-tapered aperture, thus reducing length and corresponding amount of wire used to form the insulated electric cables 52 of the electrical wire windings 50 and reducing packaging size of an associated electric motor. It is appreciated that the features of the end elements 20 including radially-oriented inwardly projecting teeth 29 and corresponding radially-oriented inwardly opening tapered apertures 28 may be fabricated directly in a end of the assembled laminate stack 13 of the stator core 11.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A substantially hollow cylindrical stator core having a longitudinal axis comprising a plurality of winding slots longitudinally parallel with the longitudinal axis each having first and second ends wherein the slots taper progressively larger closer to the ends of the slots.

2. The stator core of claim 1 further comprising electrical wire windings disposed through the winding slots, wherein each electrical wire winding is bent as it exits a respective winding slot where the slot tapers progressively larger.

3. A stator core for a stator of an induction motor, comprising:
a substantially hollow cylindrical laminate stack including a plurality of inwardly projecting teeth configured to form inwardly opening slots between adjacent teeth; and
an end element assembled onto an end of the laminate stack and including a plurality of tapered apertures aligned with the inwardly opening slots of the laminate stack.

4. The stator core of claim 3, wherein the plurality of tapered apertures taper from an outer surface of the end element to an inner surface of the end element, the inner surface of the end element contiguous to the laminate stack.

5. The stator core of claim 3, wherein the end element includes a plurality of inwardly projecting teeth aligned with the inwardly projecting teeth of the laminate stack.

6. The stator core of claim 3, wherein the end element assembled onto the end of the laminate stack includes a plurality of laminate sheets progressively stacked from the end of the laminate stack, each laminate sheet including a plurality of apertures wherein each aperture of each progressively stacked laminate sheet is larger than the aperture of the previously stacked laminate sheet thereby defining the plurality of tapered apertures.

7. The stator core of claim 6, wherein the apertures of each progressively stacked laminate sheet comprise beveled apertures.

8. The stator core of claim 3, wherein the inwardly opening slots between adjacent teeth are rectangularly-shaped.

9. A stator core for a stator of an induction motor, comprising:
a stator core comprising a laminate stack including a plurality of contiguous inwardly projecting teeth configured to form inwardly opening slots and first and second end elements mounted on first and second ends of the laminate stack, each end element including a plurality of tapered apertures aligned with the inwardly opening slots of the laminate stack; and
electrical wire windings each comprising a first portion contained within a respective inwardly opening slot of the stator core, and bend portions exiting the stator core through respective tapered apertures in the first and second end elements, and exterior portions external to each of the first and second end elements of the stator core.

10. The stator for the induction motor of claim 9, wherein the exterior portion of one of the electrical wire windings electrically connects to the exterior portion of another one of the electrical wire windings.

11. The stator core of claim 9, wherein each of the first and second end elements includes a plurality of laminate sheets progressively stacked from the respective end of the laminate stack, each laminate sheet including a plurality of apertures wherein each aperture of each progressively stacked laminate sheet is larger than the aperture of the previously stacked laminate sheet thereby defining the plurality of tapered apertures.

12. The stator core of claim 9, wherein the apertures of each progressively stacked laminate sheet comprise beveled apertures.

13. The stator core of claim 9, wherein the inwardly opening slots are rectangularly-shaped.
